(19) United States
(12) Patent Application Publication
(10) Pub. No.: US 2013/0329917 A1
(43) Pub. Date: Dec. 12, 2013

(54) PORTABLE ELECTRONIC DEVICE HAVING UNIVERSAL EARPHONE JACK

(71) Applicant: YANG ZHANG, Shenzhen City (CN)

(72) Inventor: YANG ZHANG, Shenzhen City (CN)

(21) Appl. No.: 13/660,000

(22) Filed: Oct. 25, 2012

(30) Foreign Application Priority Data
Jun. 7, 2012 (CN) 2012101857910

(51) Int. Cl. H02B 1/00

(52) U.S. Cl. 381/123

(57) ABSTRACT

A portable electronic device includes an earphone jack for receiving an earphone plug, a switch unit and a signal processing unit. The switch circuit operates in a first mode, a second mode, and a third mode. The signal processing unit identifies a type of the earphone plug and controls the switch unit to switch to the first mode, the second mode, or the third mode according to the type of the earphone plug.

### BACKGROUND

1. Technical Field

The disclosure generally relates to portable electronics devices, and particularly to a portable electronic device having a universal earphone jack, which can receive multiple earphone plugs.

2. Description of Related Art

A three-pin earphone plug usually includes a first contact portion, a second contact portion, and a third contact portion orderly formed on the earphone plug. In a three-pin earphone plug shown in FIG. 3, the first contact portion is a left channel point REC_L, the second contact portion is a right channel point REC_R, and the third contact portion is a ground point GND. A four-pin earphone plug usually includes a first contact portion, a second contact portion, a third contact portion and a fourth contact portion orderly formed thereon. In a first type of four-pin earphone plug shown in FIG. 4, the first contact portion is a left channel point REC_L, the second contact portion is a right channel point REC_R, the third contact portion is a microphone channel point MIC, and the fourth contact portion is a ground point GND. In a second type of four-pin earphone plug shown in FIG. 5, the first contact portion is a left channel point REC_L, the second contact portion is a right channel point REC_R, the third contact portion is a ground point GND, and the fourth contact portion is a microphone channel point MIC. A related portable electronic device usually can use only one of the three-pin earphone plug, the first type of four-pin earphone plug, or the second type of four-pin earphone plug, and lacks flexibility.

Therefore, there is room for improvement within the art.

### BRIEF DESCRIPTION OF THE DRAWINGS

Many aspects of the present embodiment can be better understood with reference to the following drawings. The components in the drawings are not necessarily drawn to scale, the emphasis instead being placed upon clearly illustrating the principles of the present embodiment.

FIG. 1 is a block diagram of a portable electronic device, according to an exemplary embodiment.

FIG. 2 is a circuit diagram of the portable electronic device shown in FIG. 1.

FIG. 3 is a schematic view of a related three-pin earphone plug.

FIG. 4 is a schematic view of a related first type of four-pin earphone plug.

FIG. 5 is a schematic view of a related second type of four-pin earphone plug.

### DETAILED DESCRIPTION

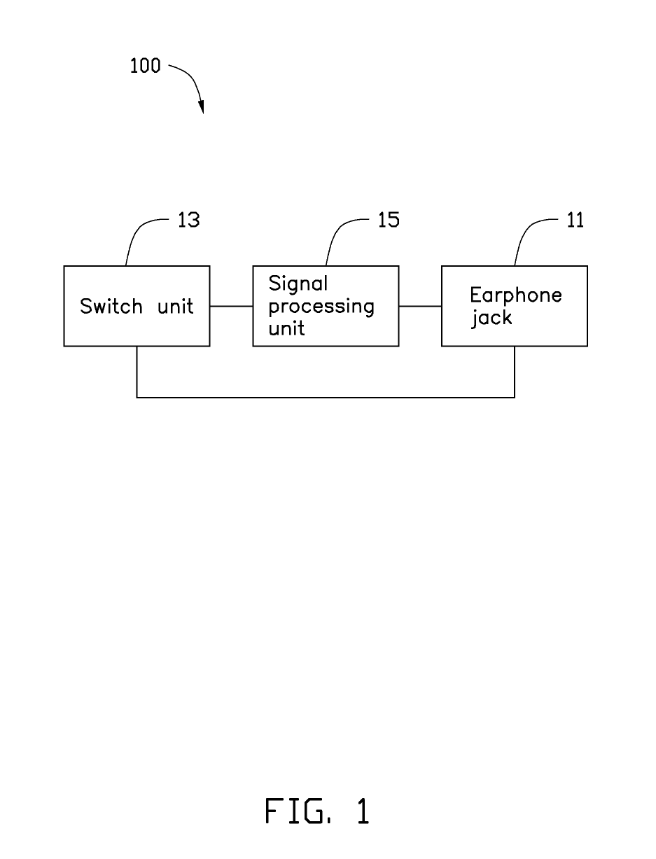

FIG. 1 shows a block diagram of a portable electronic device 100, according to an exemplary embodiment. The portable electronic device 100 includes an earphone jack 11, a switch unit 13, and a signal processing unit 15.

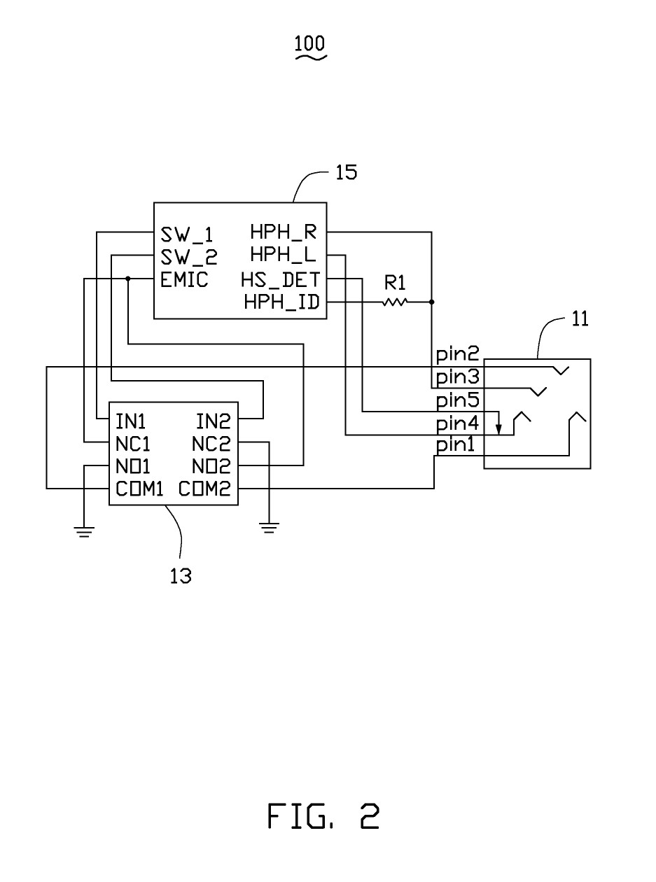

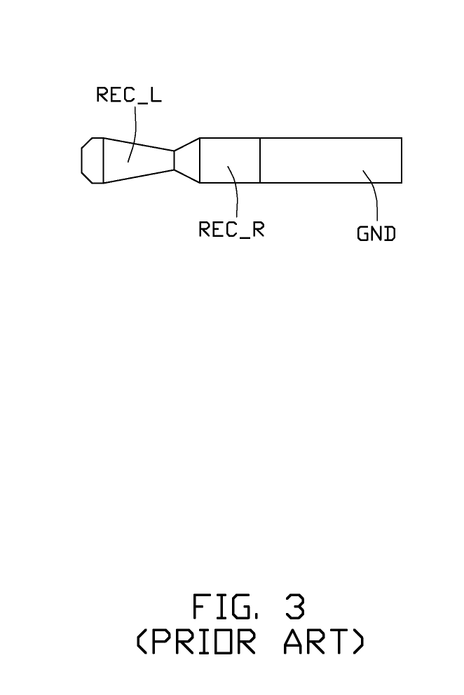

FIG. 2 shows an embodiment of the earphone jack 11. The earphone jack 11 includes a first contact pin1, a second contact pin2, a third contact pin3, a fourth contact pin4, and a fifth contact pin5. The earphone jack 11 can receive different types of earphone plugs. When a three-pin earphone plug shown in FIG. 3 is received in the earphone jack 11, the first and second contacts pin1 and the second contact pin2 are both connected to the ground point GND, and the third contact pin3 and the fourth contact pin4 are connected to the right channel point REC_R and the left channel point REC_L, respectively.

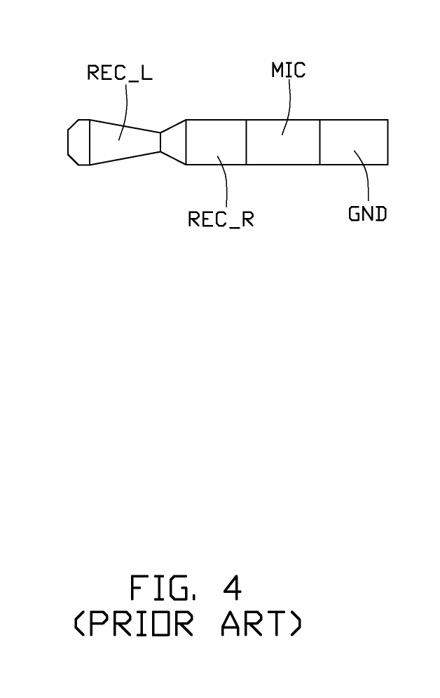

When a first type of four-pin earphone plug shown in FIG. 4 is received in the earphone jack 11, the first contact pin1, the second contact pin2, the third contact pin3, and the fourth contact pin4 are connected to the ground point GND, the microphone point MIC, the right channel point REC_R, and the left channel point REC_L, respectively.

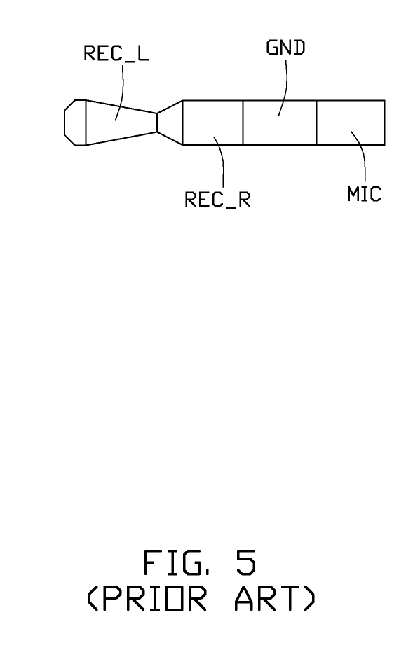

When a second type of four-pin earphone plug shown in FIG. 5 is received in the earphone jack 11, the first contact pin1, the second contact pin2, the third contact pin3, and the fourth contact pin4 are connected to the microphone point MIC, the ground point GND, the right channel point REC_R, and the left channel point REC_L, respectively.

The switch unit 13 may be a NLAS4684FCT1G switch chip and includes two input contacts IN1, IN2, a first common contact COM1, a second common contact COM2, a first normally open contact NO1, a second normally open contact NO2, a first normally closed contact NC1, and a second normally closed contact NC2. Both the first normally open contact NO1 and the second normally closed contact NC2 are connected to ground. The first common contact COM1 and the second common contact COM2 are connected to the second contact pin2 and the first contact pint, respectively.

The switch unit 13 includes a first mode, a second mode, and a third mode. In the first mode, the first common contact COM1 and the second common contact COM2 are connected to the first normally closed contact NC1 and the second normally closed contact NC2, respectively. In the second mode, the first common contact COM1 and the second common contact COM2 are connected to the first normally open contact NO1 and the second normally open contact NO2, respectively. In the third mode, the first common contact COM1 is electronically connected to the first normally open contact NO1. The second common contact COM2 is electronically connected to the second normally closed contact NC2.

The signal processing unit 15 includes a left channel pin HPH_L, a right channel pin HPH_R, an audio receiving pin EMIC, a first detecting pin HPH_ID, a first control pin SW_1, and a second control pin SW_2. The left channel pin HPH_L is connected to the fourth contact pin4. The right channel pin HPH_R is connected to the third contact pin3. A first terminal of the audio receiving pin EMIC is connected to the first normally closed contact NC1 and the second normally open contact NO2. A second terminal of the audio receiving pin EMIC is connected to an audio processing circuit (not shown) set in the portable electronic device 100. The audio processing circuit is used to receive and process audio from the third contact portion of the first type of four-pin earphone plug or the fourth contact portion of the second type of four-pin earphone plug.

In this embodiment, the first detecting pin HPH_ID is electronically connected to the third contact pin3 through a resistor R1 and determines the type of the earphone plug received in the earphone jack 11 according to the voltage of the third contact pin3.

The first control pin SW_1 and the second control pin SW_2 are connected to the two input contacts IN1, IN2, respectively. The first and second control pins SW_1, SW_2 switch the switch unit 13 to a corresponding mode according to the type of the earphone plug received in the earphone jack 11.

When a first type of four-pin earphone plug shown in FIG. 4 is received in the earphone jack 11, the second contact pin2 is electronically connected to the microphone point MIC of the first type of four-pin earphone plug and is further connected to the audio receiving pin EMIC through the first common contact COM1 and the first normally closed contact NC1. The first contact pin1 is electronically connected to the ground point GND of the first type of four-pin earphone plug and is further connected to ground through the second common contact COM2 and the second normally closed contact NC2. In this way, there is little to no bias voltage between the first type of four-pin earphone plug and the earphone jack 11. Therefore, the first detecting pin HPH_ID will receive a low level signal (e.g., logic 0) through the third contact pin3 and determine that the first type of four-pin earphone plug is correctly received in the earphone jack 11. Then, both the first and second control pins SW_1, SW_2 output a low level signal (e.g., logic 0) to switch the switch unit 13 to the first mode.

When a second type of four-pin earphone plug shown in FIG. 5 is received in the earphone jack 11, the second contact pin2 is electronically connected to the ground point GND of the second type of four-pin earphone plug and is further connected to the audio receiving pin EMIC through the first common contact COM1 and the first normally closed contact NC1. The first contact pin1 is electronically connected to the microphone point MIC of the second type of four-pin earphone plug and is further connected to ground through the second common contact COM2 and the second normally closed contact NC2. In this way, there is a bias voltage between the second type of four-pin earphone plug and the earphone jack 11. Therefore, the first detecting pin HPH_ID will receive a high level signal (e.g., logic 1) through the third contact pin3 and determines that the second type of four-pin earphone plug is incorrectly received in the earphone jack 11. Then, both the first and second control pins SW_1, SW_2 output a high level signal (e.g., logic 1) to switch the switch unit 13 to the second mode, which will make the second type of four-pin earphone plug be correctly received in the earphone jack 11.

When a three-pin earphone plug shown in FIG. 3 is received in the earphone jack 11, no matter if the switch unit 13 is in the first mode or the second mode, there is a bias voltage between the three-pin earphone plug and the earphone jack 11. Therefore, the first detecting pin HPH_ID will receive a high level signal (e.g., logic 1) through the third contact pin3. Therefore, the first and second control pins SW_1, SW_2 will respectively output a high level signal (e.g., logic 1) and a low level signal (e.g., logic 0) to switch the switch unit 13 to the third mode, which will make the three-pin earphone plug be correctly received in the earphone jack 11.

When an earphone plug is received in the earphone jack 11, the signal processing unit 15 obtains a voltage of the third contact pin3 through the first detecting pin HPH_ID and determines the type of the received earphone plug based on the obtained voltage. In detail, when the first detecting pin HPH_ID receives a low level signal (e.g., logic 0) through the third contact pin3, the signal processing unit 15 determines a first type of four-pin earphone plug is received in the earphone jack 11. Next, the first and second control pins SW_1, SW_2 both output a low level signal (e.g., logic 0) under the control of the signal processing unit 15 to control the switch unit 13 to switch to the first mode. That is, the first common contact COM1 and the second common contact COM2 are respectively connected to the first normally closed contact NC1 and the second normally closed contact NC2.

When the testing pin HPH_ID receives a high level signal (e.g., logic 1) through the third contact pin3, the signal processing unit 15 determines a second type of four-pin earphone plug or a three-pin earphone plug is received in the earphone jack 11. Next, the first and second control pins SW_1, SW_2 both output a high level signal (e.g., logic 1) under the control of the signal processing unit 15 to control the switch unit 13 to switch to the second mode. That is, the first common contact COM1 and the second common contact COM2 are respectively connected to the first normally open contact NO1 and the second normally open contact NO2. Then, the signal processing unit 15 continues to obtain a voltage of the third contact pin3 through the first detecting pin HPH_ID.

If the first detecting pin HPH ID receives a low level signal (e.g., logic 0) through the third contact pin3, the signal processing unit 15 determines the second type of four-pin earphone plug is received in the earphone jack 11. If the first detecting pin HPH_ID receives a high level signal (e.g., logic 1) again, the signal processing unit 15 determines the three-pin earphone plug is received in the earphone jack 11. Then, the first and second control pins SW_1, SW_2 are respectively output a high level signal (e.g., logic 1) and a low level signal (e.g., logic 0) under the control of the signal processing unit 15 to control the switch unit 13 to switch to the third mode. That is, the first common contact COM1 is electronically connected to the first normally open contact NO1. The second common contact COM2 is electronically connected to the second normally closed contact NC2. Therefore, the three-pin earphone plug, the first type of four-pin earphone plug, and the second type of four-pin earphone plug can be freely used by the portable electronic device 100.

It is notable that the first detecting pin HPH_ID, the first control pin SW_1, and the second control pin SW_2 can be integrated with General Purpose Input Output (GPIO) terminals (not shown) of the signal processing unit 15.

In other embodiments, the signal processing unit 15 further includes a second detecting pin HS_DET. The second detecting pin HS_DET is electronically connected to the fifth contact pin5. When an earphone plug is received in the earphone jack 11, the fifth contact pin5 is disconnected from the fourth contact pin4 and is turned to a high level from a low level (e.g., from logic 0 to logic 1). Accordingly, the second detecting pin HS_DET can determine whether an earphone plug is received in the earphone jack 11 by the voltage of the fifth contact pin5.

In other embodiments, the first detecting pin HPH_ID can be electronically connected to the fourth contact pin4 through the resistor R1 and determines the type of the earphone plug received in the earphone jack 11 according to the voltage of the fourth contact pin4.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A portable electronic device, comprising:
an earphone jack configured to receiving an earphone plug;
a switch unit connected to the earphone jack, the switch unit operating in a first mode, a second mode, or a third mode; and
a signal processing unit connected to the earphone jack and the switch unit, wherein the signal processing unit identifies a type of the earphone plug received in the earphone jack and controls the switch unit to switch to the first mode, the second mode, or the third mode according to the type of the earphone plug.

2. The portable electronic device as claimed in claim 1, wherein the earphone jack includes a first contact, a second contact, a third contact and a fourth contact; the first contact and the second contact are connected to the switch unit, the third contact and the fourth contact are connected to the signal processing unit.

3. The portable electronic device as claimed in claim 2, wherein the signal processing unit comprises a left channel pin connected to the fourth contact, a right channel pin connected to the third contact, a first control pin, and a second control pin, the first and second control pins are connected to the switch unit.

4. The portable electronic device as claimed in claim 3, wherein the switch unit comprise two input contacts connected to first and second control pins, a first common contact connected to the second contact, a second common contact connected to the first contact, a first normally open contact connected to ground, a second normally open contact connected to an audio receiving pin of the signal processing unit, a first normally closed contact connected the audio receiving pin, and a second normally closed contact connected to ground.

5. The portable electronic device as claimed in claim 4, wherein in the first mode, the first common contact is connected to the first normally closed contact, the second common contact is connected to the second normally closed contact.

6. The portable electronic device as claimed in claim 4, wherein in the second mode, the first common contact is connected to the first normally open contact, the second common contact is connected to the second normally open contact.

7. The portable electronic device as claimed in claim 4, wherein in the third mode, the first common contact is connected to the first normally open contact, the second common contact is connected to the second normally closed contact.

8. The portable electronic device as claimed in claim 2, wherein the signal processing unit comprises a first detecting pin connected to third contact or the fourth contact, the signal processing unit determines the type of the earphone plug received in the earphone jack according to the voltage of the first detecting pin.

9. The portable electronic device as claimed in claim 8, wherein when the switch unit is in the first mode and the first detecting pin receives a low level signal, the signal processing unit determines a first type of four-pin earphone plug received in the earphone jack.

10. The portable electronic device as claimed in claim 8, wherein when the switch unit is in the first mode and the first detecting pin receives a high level signal, the signal processing unit determines a type of the earphone plug received in the earphone jack after the first control pin and the second control pin both output a high level to switch the switch unit to the second mode.

11. The portable electronic device as claimed in claim 10, wherein when the switch unit is in the second mode and the first detecting pin receives a low level signal, the signal processing unit determines a second type of four-pin earphone plug received in the earphone jack.

12. The portable electronic device as claimed in claim 10, wherein when the switch unit is in the second mode and the first detecting pin receives a high level, the signal processing unit determines a three-pin earphone plug received in the earphone jack and controls the first control pin and the second control pin respectively output a high level and a low level to switch the switch unit to the third mode.

13. The portable electronic device as claimed in claim 2, wherein the earphone jack further includes a fifth contact connected to the fourth contact, the signal processing unit further comprises a second detecting pin connected to the fifth contact, the second detecting pin determines whether the earphone plug is received in the earphone jack by the voltage of the fifth contact.

14. The portable electronic device as claimed in claim 8, wherein the first detecting pin, the first control pin, and the second control pin are integrated with general purpose input output terminals of the signal processing unit.
